(19) United States
(12) Patent Application Publication
(10) Pub. No.: US 2008/0279088 A1
(43) Pub. Date: Nov. 13, 2008

(54) Record Carrier and Method of Recording an Image

(75) Inventors: Erwin Rinaldo Meinders, Eindhoven (NL); Andrei Mijiritskii, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/599,993

(22) PCT Filed: Apr. 11, 2005
(86) PCT No.: PCT/IB05/51170

§ 371 Date: Oct. 17, 2006

(30) Foreign Application Priority Data
Apr. 20, 2004 (EP) 04101628.8

(51) Int. Cl. G11B 7/26; B41J 3/407

(52) U.S. Cl. 369/283; 347/262

(57) ABSTRACT

A record carrier (10) and a method of recording an image on a record carrier (10) are provided. A plurality of optical property changing layers (12, 14, 16) that change their Color upon the application of thermal energy applied by a laser beam (18) is provided. It depends on the power of the laser beam (18) which layer of the stack is reached and thereby colored. Since the temperature to induce an optical property change increases from one layer to the subsequent layer, a fine adjustment of the laser power is not needed.

### FIELD OF THE INVENTION

The present invention relates to a record carrier and to a method of writing an image on a record carrier. Particularly, the present invention is directed to the recording of an image on a record carrier within an optical recorder by using a laser that is part of the optical recorder.

### BACKGROUND OF THE INVENTION

In many applications, it is advantageous to write a label on an optical record carrier. In prior art, several approaches have been suggested. For example, an optical disk can simply be marked by hand with a pen or a marker. Another possibility is to use an adhesive label that can be fixed to the disk. More elaborate techniques have been proposed that use the same optical unit within an optical recorder as is used for writing the data. Several possibilities have been proposed to write the label on the same side as the data, for example in the remaining unwritten part of the disk, via structured writing of redundant data blocks such that visible patterns result. The drawback of this technique is the poor visible optical contrast and the fact that only a monochromic image can be the result of such a writing process.

A further technique has been proposed in US 2003/0133005 A1. Thermally-sensitive layers are provided on an optical disk, and a laser head within the optical recorder is modulated in order to burn through the thermally-sensitive layers. Since these thermally-sensitive layers change color when heated, the application of the laser beam produces a color, particularly a colored pixel on the disk. Since different thermally-sensitive layers can produce different colors, the provision of multiple layers may result in a colored image. However, the problem this prior art is related to the appropriate application of laser power to a particular layer within a stack of several layers. If the power is not adjusted so that exactly the layer producing the desired color is reached, this might lead to images with undesired coloring effects or poor optical contrast.

An object of the present invention is to provide a record carrier and a method of recording an image of high quality using a laser beam, so that the adjustment of the laser power is not critical as regards the optical quality.

### SUMMARY OF THE INVENTION

The above objects are solved by the features of the independent claims. Further developments and preferred embodiments of the invention are outlined in the dependent claims.

In accordance with the present invention, there is provided a record carrier comprising a plurality of stacked layers, the optical properties of at least a part of the stacked layers being changeable by applying heat, thereby providing a stack of optical property changing layers, so that a visible pattern can be written on the record carrier by applying a laser beam to an upper surface of the stacked layers, wherein, depending on the power of the laser beam, the laser beam is able to reach the lower layers of the stack of optical property changing layers, characterized in that the temperature required to induce an optical property change increases from the upper to the lower optical property changing layers. Thus, the change of the optical properties of the layers is achieved by modulating the laser power. In order to change the optical properties of the upper layer only a low laser power is required. If the optical properties of the layer below the upper layer are to be changed, the laser power is increased. The laser power has to be increased by a considerable amount since the temperature required to induce an optical property change in the layer below the upper layer is higher than the temperature required to induce an optical property change in the upper layer. Thus, when using the low power in order to induce an optical power change in the upper layer, an undesired optical property change in the layer below the upper layer is unlikely to occur. Therefore, the laser power difference for optical property changes in adjacent layers is large, hence the adjustment of the laser power is uncritical.

The present invention is particularly advantageous with respect to an embodiment, wherein the plurality of stacked layers comprises a substrate on top of which the stack of optical property changing layers is arranged, and wherein the highest temperature is required for inducing an optical property change of the optical property changing layer that is arranged at the smallest distance to the substrate. Thus, the laser beam is supplied from the side of the optical property changing layers opposite to the substrate. Therefore, the substrate has no disturbing influence on the correct application of an appropriate laser power.

According to a preferred embodiment, a cover layer is arranged on top of the optical property changing layers. The cover layer protects the optical property changing layers so that the material for these layers can be chosen independently from the mechanical durability. Further, the thickness of the cover layer can be selected so that the arrangement is tuned to the system optics, thereby ensuring a correct focusing of the laser beam to the layer that is to be thermally influenced.

This feature plays an important role when the substrate is formed by an optical disk. In systems for optical recording, the optical system is tuned to the transparent layers that have to be penetrated by the laser beam before reaching the layer on which the data are written. For DVD this layer has a thickness of 0.6 nm n. Advantageously, a cover layer arranged on top of the optical property changing layers is of the same thickness. However, it might also be advantageous to have a cover layer of a different thickness, so that a laser spot with a larger writing spot size is generated. A larger spot is preferable to reduce the total writing time. The largest possible spot size depends on the required laser power to initiate the thermal decomposition.

According to another embodiment, the plurality of stacked layers comprises a substrate on top of which the stack of optical property changing layers is arranged, and wherein the highest temperature is required for inducing an optical property change of the optical property changing layer that is arranged at the greatest distance to the substrate. In this embodiment, the substrate has, besides supporting the optical property changing layers, the characteristic to receive the laser beam before it reaches the optical property changing layers. In that sense, the present invention is not limited to the labeling of the optical disks but can also be applied in order to apply an image on different objects, that for example, have a layered structure as presently discussed.

Advantageously, the stack of optical property changing layers comprises at least three layers, the optical power change being a color change and the color change of the at least three layers being different. Due to the provision of three layers that are able to produce different colors, a colored image can be provided. With an appropriate selection of the colors involved, a colored picture can be generated that comprises all colors from the optical spectrum.

Particularly, the color change of a particular layer induced by the laser beam is determined by the material the particular layer is made of. Possible materials are Fe₂O₃ for the red color, ZnCO₂O₄ for green, CoAl₂O₄ for blue. A further example is a layer of (Ti_{0.85}Ni_{0.05}Nb_{0.1})O₂ for yellow. Additional systems are Si—Cu, Sn—In, and Bi—Sn.

Preferably the color change induced by the laser beam is influenced by a chemical reaction between adjacent layers. This chemical reaction can influence the color change in addition to the thermally induced decomposition of a single layer, or the color change can completely be determined by the chemical reaction.

In this context it is useful that interface layers are arranged between optical property changing layers. These interface layers provide barriers that improve the chemical stability at low temperatures. A chemical reaction between two adjacent layers is only possible when the intermediate layer breaks down due to heating. In this way, the size of the image pixels is better controllable.

In accordance with the present invention, there is further provided a method of recording an image on a record carrier, the record carrier comprising a plurality of stacked layers, the optical properties of at least a part of the stacked layers being changeable by applying heat, thereby providing a stack of optical property changing layers, so that a visible pattern can be written on the record carrier by applying a laser beam to an upper surface of the stacked layers, wherein, depending on the power of the laser beam, the laser beam is able to reach the lower layers of the stack of optical property changing layers, characterized in that the temperature required to induce an optical property change increases from the upper to the lower optical property changing layers.

Moreover an optical recorder for recording an image on a record carrier according to the present invention is provided.

Thus, the advantages and particularities of the record carrier according to the present invention are also realized in relation to a method and to an optical recorder. This is also applicable with relation to the preferred embodiments of the record carrier that can be translated into preferred embodiments of the method according to the invention and of the optical recorder according to the invention.

These and other aspects of the invention will be apparent from and elucidated with reference to the embodiments described hereinafter.

### BRIEF DESCRIPTION OF THE DRAWINGS

FIG. 1 shows a schematic drawing of an optical recorder according to the invention;

FIG. 2 shows a schematic drawing of a record carrier according to the present invention;

FIG. 3 shows a flow chart illustrating a preferred embodiment of a method according to the present invention.

### DESCRIPTION OF PREFERRED EMBODIMENTS

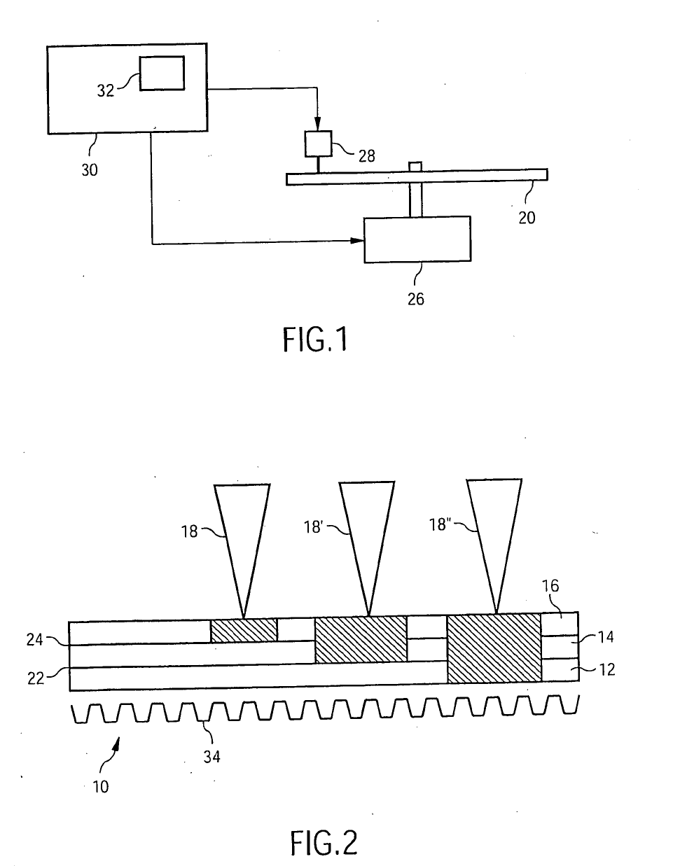

FIG. 1 shows a schematic drawing of an optical recorder according to the invention. Only components that are directly related to the present invention are shown in the schematic drawing. An optical disk 20 is arranged on a motor 26 of the optical recorder. A laser 28 is arranged so that a laser beam from the laser 28 can reach the optical disk 20. A controller 30 is provided in order to position the laser 28 so that the laser beam can reach a particular position on the optical disk 20. This is achieved by for example a translational movement of the laser 28 and a rotational movement of the disk 20 by means of the motor 26. The positioning of the laser 28 is supported by a tracking system that can be similar to tracking systems of prior art that are used for reading and/or writing with respect to an optical storage medium. The controller 30 further comprises a memory 32 in which data are stored on basis of which an image is recorded on the optical disk 20.

The laser beam from the laser 28 is directed to the back of the optical disk 20. In this sense, the laser 28 can be a particular laser dedicated for recording the image on the optical disk 20. Another possibility is to provide a turning mechanism in order to turn the disk from a recording/reading position (not shown in FIG. 1) into an image recording position (shown in FIG. 1). Another possibility is to manually turn the disk in order to practice the present invention.

The memory 32 containing the image data is not necessarily a part of the controller 30. For example, the memory can be an external memory. Another possibility is that data from the optical disk 20 contain the image information, so that, after reading these data, the image can be recorded on the back of the disk 20.

FIG. 2 shows a schematic drawing of a record carrier according to the present invention. The record carrier 10 comprises three stacked layers 12, 14, 16. For example, these layers are formed on the back of the optical disk 20 from FIG. 1, covering at least part of its surface. In this sense, the optical disk 20 acts as a substrate for the layers 12, 14, 16. A grooved layer 34 is provided for tracking purposes. On top of the layers 12, 14, 16 a cover layer (not shown) can be provided. This is particularly advantageous when the optical reading/writing unit of an optical recorder is used since the thickness of the cover layer can be adapted to the optical system. The layers 12, 14, 16 are optical property changing layers in the sense of the present invention. Particularly, the layers 12, 14, 16 change their color upon the application of thermal energy. For example, the initial color of the layers 12, 14, 16 is white.

According to a preferred embodiment, upon the application of thermal energy, the layer 12 changes its color from white to green. The layer 14 changes its color from white to blue when thermal energy is applied. The upper layer 16 changes from white to red upon the application of thermal energy. If only a low laser power is applied, the laser beam 18 only reaches the upper layer 16. Thus, a red pixel is generated. If a laser beam 18′ of moderate power is applied, this laser beam 18 is able to burn through the upper layer and to reach the layer 14. In case that the upper layer 16 becomes uncolored and transparent upon the application of moderate power, the color of the pixel corresponds to the color of the thermally decomposed medium layer 14. Thus, a blue pixel is provided. Similarly, upon application of a high power laser beam 18″ the laser beam 18″ is able to burn through two layers 16, 14 so that the lower layer 12 can change its color. One possibility is to obtain uncolored and transparent layers 16 and 14 upon the application of high power, thereby producing a pixel having the color of the thermally decomposed lower layer 12, i.e. a green pixel is provided.

According to a different embodiment, it is not necessarily required to produce uncolored and transparent layers on top of the lowest layer to be reached by the laser beam. It is also possible to produce or maintain several colored stacked layers. In this case, a pixel that is generated by a laser beam that e.g. reaches the lowest layer 12 does not appear as a pixel having the color of the thermally decomposed lower layer 12 but as a pixel generated by the mixing of the colors involved. Thus, the optical appearance of the pixels can be widely influenced by an appropriate selection of the temperature dependency of the colors.

According to a still further embodiment, it is also possible to start with an upper layer that is colored without any application of a laser beam. A low laser power leads to decomposition of layers 16 and 14. A high or medium laser power leads to a decomposition of layers 16, 14 and 12. Thus, an appropriate selection of the colors of the decomposed layers can for example lead to blue color due to the mixing of the colors of layers 16 and 14 and to green color due to the mixing of the colors of layers 16, 14, and 12. In any case, the optical appearance of a pixel is determined by the optical properties of all visible layers.

According to the invention, the decomposition temperature, i.e. the temperature needed for a color change, is different for the different layers 12, 14, 16. The layer 16 decomposes at decomposition temperature T₁, the layer 14 decomposes at decomposition temperature T₂, T₂>T₁, layer 12 decomposes at decomposition temperature T₃, T₃>T₂. Due to this selection of decomposition temperatures, a large difference in laser power is required in order to switch from the decomposition of one layer to the other layer. Thus, the adjustment of the laser power is not critical. Both, the laser power and the heat absorption of the three layers 12, 14, 16 determine the final temperature distribution in the recording stack.

At the interfaces 22, 24 of the layers 12, 14, 16, interface layers can be provided. These interface layers 22, 24 can act as a thermal barrier in order to further enlarge the required laser power modulation in order to reach different layers 12, 14, 16. In a further embodiment, the color change of the layers is influenced by the chemical reaction between the adjacent layers. In this case, the interface layers 22, 24 improve the chemical stability at room temperature. In other words, an unwanted chemical reaction without applying thermal energy by a laser beam is avoided.

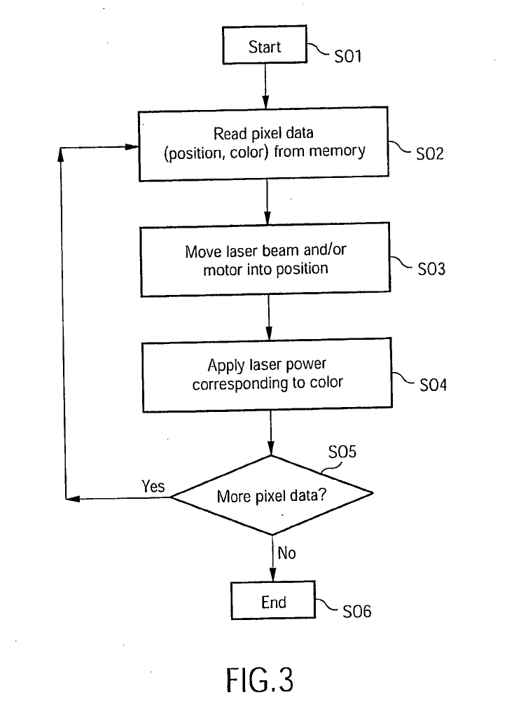

FIG. 3 shows a flow chart illustrating a preferred embodiment of a method according to the present invention. After the start of the recording procedure in step S01, pixel data, i.e. the position and the color of the pixels, are read from a memory in step S02. Consequently, the laser beam and/or the motor move into a position so that the desired location of the record carrier can be achieved by the laser beam in step S03. In step S04 a laser power is applied that corresponds to the color information read from the memory. Thereby, a colored pixel of the desired color is recorded. In step S05 it is judged whether more pixel data are to be processed. If not, the recording procedure ends at step S06. If yes, the next pixel data are read step S02.

It is noted that the system and the method according to the present invention can be different from the examples shown in the drawings and described above. For example, more than one laser can be supplied within the system so that the different needs of reading and writing data and of recording an image to the record carrier can be optimized with respect to the properties of the laser. Furthermore, the present invention is not limited to an application related to optical recording in the sense of CD, DVD, etc. The record carrier according to the present invention can be any suitable object on which an image is to be recorded. Thus, the present invention provides, on the on hand, an improvement of optical recording by providing a desirable labeling strategy, and, on the other hand, a basic printing concept.

Equivalents and modifications not described above may also be employed without departing from the scope of the invention, which is defined in the accompanying claims.

1. A record carrier (10) comprising a plurality of stacked layers (12, 14, 16), the optical properties of at least a part of the stacked layers being changeable by applying heat, thereby providing a stack of optical property changing layers, so that a visible pattern can be written on the record carrier by applying a laser beam (18) to an upper surface of the stacked layers, wherein, depending on the power of the laser beam, the laser beam is able to reach the lower layers of the stack of optical property changing layers, characterized in that the temperature required to induce an optical property change increases from the upper to the lower optical property changing layers.

2. The record carrier according to claim 1, wherein the plurality of stacked layers comprises a substrate on top of which the stack of optical property changing layers is arranged, and wherein the highest temperature is required for inducing an optical property change of the optical property changing layer that is arranged at the smallest distance to the substrate.

3. The record carrier according to claim 1, wherein a cover layer is arranged on top of the optical property changing layers.

4. The record carrier according to claim 2, wherein the substrate is formed by an optical disk (20).

5. The record carrier according to claim 1, wherein the plurality of stacked layers comprises a substrate on top of which the stack of optical property changing layers is arranged, and wherein the highest temperature is required for inducing an optical property change of the optical property changing layer that is arranged at the greatest distance to the substrate.

6. The record carrier according to claim 1, wherein the stack of optical property changing layers comprises at least three layers, the optical power change being a color change and the color change of the at least three layers being different.

7. The record carrier according to claim 6, wherein the color change of a particular layer induced by the laser beam is determined by the material the particular layer is made of.

8. The record carrier according to claim 6, wherein the color change induced by the laser beam is influenced by a chemical reaction between adjacent layers.

9. The record carrier according to claim 6, wherein interface layers (22, 24) are arranged between optical property changing layers.

10. A method of recording an image on a record carrier, the record carrier comprising a plurality of stacked layers, the optical properties of at least a part of the stacked layers being changeable by applying heat, thereby providing a stack of optical property changing layers, so that a visible pattern can be written on the record carrier by applying a laser beam to an upper surface of the stacked layers, wherein, depending on the power of the laser beam, the laser beam is able to reach the lower layers of the stack of optical property changing layers, characterized in that the temperature required to induce an optical property change increases from the upper to the lower optical property changing layers.

11. An optical recorder for recording an image on a record carrier according to claim 1.
